(19) United States
(12) Patent Application Publication
(10) Pub. No.: US 2017/0161017 A1
(43) Pub. Date: Jun. 8, 2017

(54) TECHNOLOGIES FOR HANDS-FREE USER INTERACTION WITH A WEARABLE COMPUTING DEVICE

(71) Applicant: INTEL CORPORATION, Santa Clara, CA (US)

(72) Inventors: Fabien CHEREAU, Goyrans (FR); David GOTTARDO, Roqueford Les Pins (FR)

(21) Appl. No.: 15/039,306

(22) PCT Filed: Jun. 25, 2015
(86) PCT No.: PCT/IB2015/001310

§ 371 Date: May 25, 2016

(51) Int. Cl. G06F 3/16; G06F 1/16; G06F 3/0484

(52) U.S. Cl. CPC G06F 3/167; G06F 3/04842; G06F 1/163

(57) ABSTRACT

Technologies for hands-free user interaction include a wearable computing device having an audio sensor. The audio sensor generates audio input data, and the wearable computing device detects one or more teeth-tapping events based on the audio input data. Each teeth-tapping event corresponds to a sound of a user contacting two or more of the user's teeth together. The wearable computing device performs a user operation in response to detection of the teeth-tapping events. The audio sensor may be a microphone or a bone conductance sensor. The wearable computing device may include two or more audio sensors to generate positional audio input data. The wearable computing device may identify a teeth-tapping command and select the user interface operation based on the identified command. The teeth-tapping command may identify a tap position or a tap pattern associated with the one or more teeth-tapping events. Other embodiments are described and claimed.

### BACKGROUND

Wearable computing devices, such as smart glasses, may support multiple user input modes. For example, many wearable computing devices support voice control, including voice commands and natural language voice interfaces. Automated interpretation of voice commands is often inaccurate, particularly in the presence of background noise. Additionally, voice control is not discreet and thus may disturb nearby persons. As another example, many wearable computing devices support control through user gaze direction or blink detection. Gaze or blink control is also often not discreet, because other persons may recognize that the user is changing his or her gaze (e.g., the user may be required to break eye contact to perform gaze or blink control). Additionally, gaze or blink control may not be safe for use while the user is driving or otherwise required to maintain visual focus. As a further example, many wearable computing devices include tactile controls such as touch pads or physical buttons. Tactile controls are not discreet, and are also not hands-free and thus may not be suitable for driving.

### SUMMARY OF THE INVENTION

The invention relates to a computing device for hands-free user interaction, the computing device comprising:

an audio sensor to generate audio input data;

a tap detection module to detect one or more teeth-tapping events based on the audio input data, wherein each teeth-tapping event corresponds to a sound indicative of a user contacting two or more of the user's teeth together; and
a command module to perform a user interface operation in response to detection of the one or more teeth tapping events.

According to possible embodiments of the invention, the commuting device may have the following features:
the audio sensor comprises an air microphone;
the air microphone comprises an in-ear microphone;
the computing device further comprises a plurality of air microphones and an audio module to receive stereo audio input data from the plurality of air microphones;
the audio sensor comprises a bone conductance audio sensor;
to detect the one or more teeth-tapping events comprises to remove ambient noise from the audio input data;
to perform the user interface operation comprises to identify a teeth-tapping command based on the one or more teeth-tapping events and select the user interface operation based on the teeth-tapping command;
to identify the teeth-tapping command comprises to identify a tap position associated with the teeth-tapping command based on the audio input data, wherein the tap position corresponds to a contact location of the two or more of the user's teeth within the user's mouth, wherein to identify the tap position comprises to determine whether the tap position is a left position, a right position, or a center position;
to select the user interface operation comprises to select the user interface operation based on the tap position;
to select the user interface operation comprises to select a user interface navigation command based on the tap position;
to identify the teeth-tapping command comprises to identify a tap pattern associated with the teeth-tapping command based on the audio input data, wherein to identify the tap pattern comprises to identify two or more teeth-tapping events associated with the teeth-tapping command, wherein the two or more teeth-tapping events occur within a predefined time period;
to select the user interface operation comprises to select a user interface operation based on the tap pattern.

The invention also relates to a method for hands-free user interaction, the method comprising:

receiving, by a computing device, audio input data from an audio sensor of the computing device;

detecting, by the computing device, one or more teeth-tapping events based on the audio input data, wherein each teeth-tapping event corresponds to a sound indicative of a user contacting two or more of the user's teeth together; and

performing, by the computing device, a user interface operation in in response to detecting the one or more teeth-tapping events.

According to possible embodiments of the invention, the method may be performed as follows:
receiving the audio input data comprises receiving audio input data from an air microphone of the computing device;
receiving the audio input data further comprises receiving stereo audio input data from a plurality of air microphones of the computing device;
receiving the audio input data comprises receiving audio input data from a bone conductance audio sensor of the computing device;
detecting the one or more teeth-tapping events comprises removing ambient noise from the audio input data;
performing the user interface operation comprises identifying a teeth-tapping command based on the one or more teeth-tapping events and selecting the user interface operation based on the teeth-tapping command;
identifying the teeth-tapping command comprises identifying a tap position associated with the teeth-tapping command based on the audio input data, wherein the tap position corresponds to a contact location of the two or more of the user's teeth within the user's mouth;
selecting the user interface operation comprises selecting the user interface operation based on the tap position;
identifying the teeth-tapping command comprises identifying a tap pattern associated with the teeth-tapping command based on the audio input data;
selecting the user interface operation comprises selecting a user interface operation based on the tap pattern.

The invention also relates to a computing device comprising:

a processor; and

a memory having stored therein a plurality of instructions that when executed by the processor cause the computing device to perform the method as defined previously.

The invention also relates to one or more machine readable storage media comprising a plurality of instructions stored thereon that in response to being executed result in a computing device performing the method as defined previously.

The invention also relates to a computing device comprising means for performing the method as defined previously.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a wearable computing device for hands-free user interaction;

FIG. 2 is a perspective view of at least one embodiment of the wearable computing device of FIG. 1;

FIG. 3 is a simplified block diagram of at least one embodiment of an environment that may be established by the wearable computing device of FIGS. 1 and 2;

FIG. 4 is a simplified flow diagram of at least one embodiment of a method for hands-free user interaction that may be executed by the wearable computing device of FIGS. 1-3;

FIG. 5 is a simplified plot illustrating amplitude versus frequency for a simulated teeth-tapping event audio signal; and

FIG. 6 is a simplified plot illustrating amplitude versus time for a simulated teeth-tapping event audio signal.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

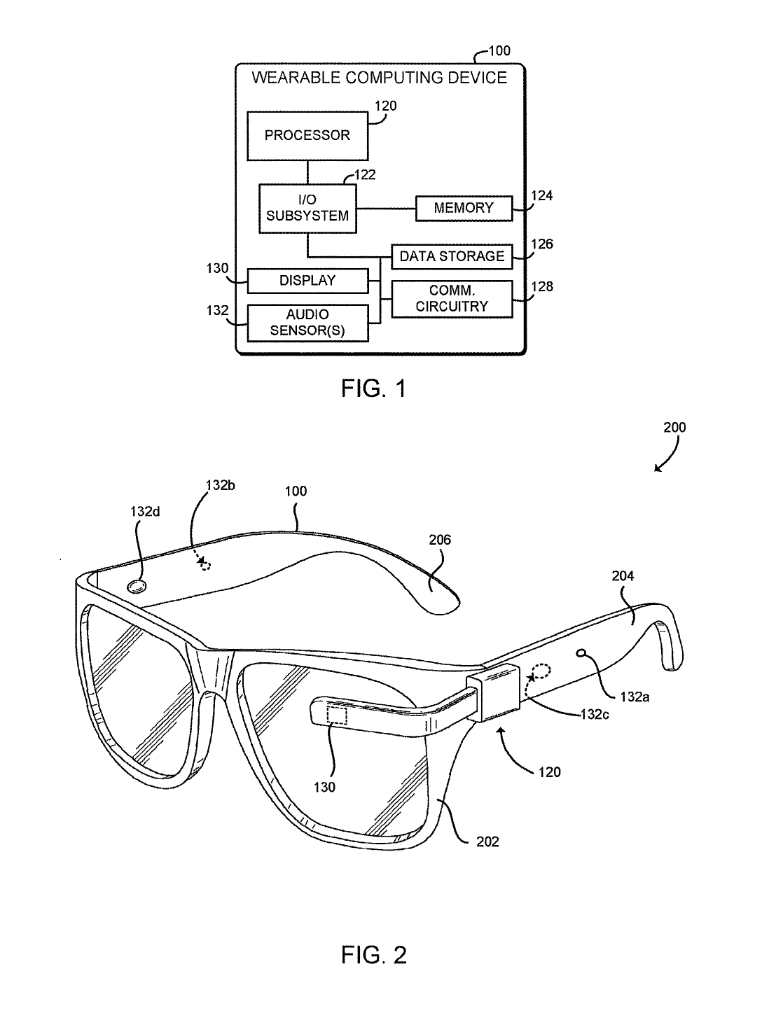

Referring now to FIG. 1, in an illustrative embodiment, a wearable computing device 100 includes, among other components, one or more audio sensors 132. The audio sensors 132 continuously monitor for sounds generated by a user of the wearable computing device 100 tapping his or her teeth together; that is, sounds or other acoustic vibrations generated by the user contacting two or more of the user's teeth together. The wearable computing device 100 detects one or more teeth-tapping events by analyzing the audio data produced by the audio sensors 132. In response to detecting one or more teeth-tapping events, the wearable computing device 100 executes a user interface operation, such as a user interface navigation command or user interface selection. Detection of teeth-tapping events may be robust and reliable, even in the presence of ambient noise. Additionally, the wearable computing device 100 may remove background noise to isolate the teeth-tapping events and provide further resistance to ambient noise. In some embodiments, the wearable computing device 100 may include one or more bone conductance audio sensors 132, which are generally insensitive to ambient noise. The user may perform teeth-tapping events quietly, without using his or her hands, and without breaking eye contact or otherwise averting his or her gaze. Thus, the wearable computing device 100 may provide relatively discreet and robust hands-free control of the wearable computing device 100.

The wearable computing device 100 may be embodied as any type of computation or computer device capable of performing the functions described herein, including, without limitation, a head-mounted display, smart eyeglasses, a smart watch, a smart phone, a computer, a tablet computer, a laptop computer, a notebook computer, a mobile computing device, a cellular telephone, a handset, a messaging device, a distributed computing system, a multiprocessor system, a processor-based system, and/or a consumer electronic device. As shown in FIG. 1, the wearable computing device 100 illustratively includes a processor 120, an input/output subsystem 122, a memory 124, a data storage device 126, and communication circuitry 128. Of course, the wearable computing device 100 may include other or additional components, such as those commonly found in smart eyeglasses (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor capable of performing the functions described herein. The processor 120 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the wearable computing device 100 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the wearable computing device 100. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the wearable computing device 100, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The communication circuitry 128 of the wearable computing device 100 may be embodied as any communication circuit, device, or collection thereof, capable of enabling communications between the wearable computing device 100 and remote devices over one or more communication networks. The communication circuitry 128 may be configured to use any one or more communication technology (e.g., wired or wireless communications) and associated protocols (e.g., Ethernet, Bluetooth®, Wi-Fi®; WiMAX, etc.) to effect such communication.

The wearable computing device 100 further includes a display 130 and one or more audio sensors 132. The display 130 of the wearable computing device 100 may be embodied as any type of display capable of displaying digital information, such as a liquid crystal display (LCD), a light emitting diode (LED), a plasma display, a cathode ray tube (CRT), or other type of display device. In some embodiments, the display 130 may be embodied as a head-mounted display mountable to the user's head and capable of projecting digital visual information in the user's field of vision. For example, in some embodiments, the display 130 may include a display source such as a liquid crystal display (LCD) or a light emitting diode (LED) array that projects display information onto a small, clear or translucent prismatic display screen positioned in front of the user's eye.

Each of the audio sensors 132 may be embodied as any sensor capable of capturing audio signals from the environment of the wearable computing device 100, such as a microphone, an audio transducer, an analog-to-digital converter (ADC), or other type of audio sensor. For example, in some embodiments each of the audio sensors 132 may be embodied as a microphone exposed to ambient air or as an in-ear microphone. In some embodiments, one or more of the audio sensors 132 may be embodied as bone conductance microphones or other bone conductance audio sensors capable of detecting acoustic vibrations transmitted through the user's skull and facial bones. By including two or more audio sensors 132, the wearable computing device 100 may be capable of detecting stereo audio signals and thus may be capable of spatially locating audio signals.

Referring now to FIG. 2, a perspective view 200 of one embodiment of the wearable computing device 100 is shown. In FIG. 2, the wearable computing device 100 is illustrated as a pair of smart eyeglasses. The smart eyeglasses 100 include a frame 202 connected to a left temple 204 and to a right temple 206. As shown, the processor 12b and the display 130 are coupled to the frame 202, and several audio sensors 132 are coupled to the temples 204, 206.

In the illustrative embodiment, the audio sensors 132a, 132b are embodied as microphones. As shown, the audio sensors 132a, 132b are positioned on the outside surfaces of the temples 204, 206. Thus, the audio sensors 132a, 132b are positioned to detect audio signals transmitted through the air surrounding the wearable computing device 100. Additionally, by being spatially separated, the audio sensors 132a, 132b are capable of detecting stereo audio input data, which may be used to spatially locate audio signals.

Continuing with the illustrative embodiment, the audio sensors 132c, 132d are embodied as bone conductance audio sensors. As shown, the audio sensors 132c, 132d are positioned on the inside surfaces of the temples 204, 206. Thus, the audio sensors 132c, 132d are positioned to be in contact with the user's body and thus are positioned to detect acoustic vibrations transmitted through the user's bones. Additionally, by being spatially separated, the audio sensors 132c, 132d are capable of detecting stereo audio input data, which may be used to spatially locate audio signals.

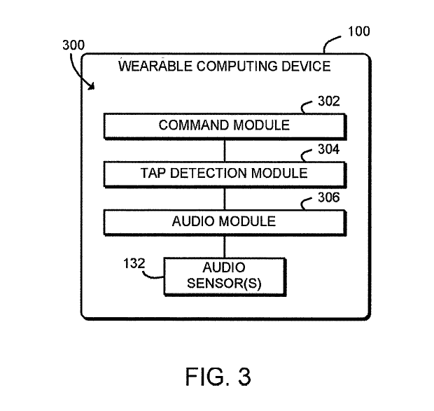

Referring now to FIG. 3, in an illustrative embodiment, the wearable computing device 100 establishes an environment 300 during operation. The illustrative environment 300 includes a command module 302, a tap detection module 304, and an audio module 306. The various modules of the environment 300 may be embodied as hardware, firmware, software, or a combination thereof. For example the various modules, logic, and other components of the environment 300 may form a portion of, or otherwise be established by, the processor 120, the audio sensors 132, or other hardware components of the wearable computing device 100. As such, in some embodiments, any one or more of the modules of the environment 300 may be embodied as a circuit or collection of electrical devices (e.g., a command circuit, a tap detection circuit, etc.).

The audio module 306 is configured to receive audio input data generated by the audio sensors 132 of the wearable computing device 100. The audio input data may be indicative of the surrounding physical environment of the wearable computing device 100, and thus may be indicative of sounds generated by the user of the wearable computing device 100. The audio module 306 may be further configured to receive stereo audio input data from two or more audio sensors 132.

The tap detection module 304 is configured to detect one or more teeth-tapping events based on the audio input data. As further described below, each teeth-tapping event corresponds to a sound indicative of the user contacting two or more of the user's teeth together. The tap detection module 304 may be configured to remove ambient noise from the audio input data prior to detecting the teeth-tapping events. In some embodiments, the tap detection module 304 may be configured to identify one or more attributes associated with the teeth-tapping command such as a tap position or a tap pattern.

The command module 302 is configured to perform a user interface operation in response to the tap detection module 304 detecting one or more teeth-tapping events. The user interface operation may include any user interface selection, user interface navigation command, or other device operation. In some embodiments, the command module 302 may be configured to identify a teeth-tapping command based on the one or more teeth-tapping events and select the user interface operation based on the identified teeth-tapping command. For example, the command module 302 may be configured to select the user interface operation based on the tap position, the tap pattern, or other attributes of the teeth-tapping command.

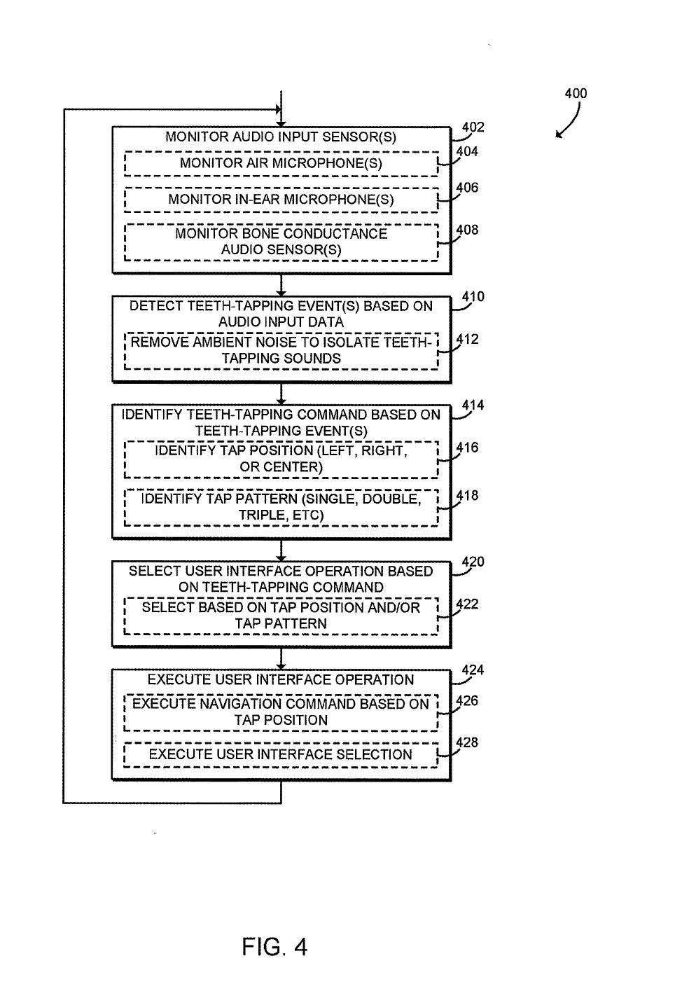

Referring now to FIG. 4, in use, the wearable computing device 100 may execute a method 400 for hands-free user interaction. The method 400 begins with block 402, in which the wearable computing device 100 monitors the audio sensors 132 for audio input data. The audio input data is indicative of sounds in the environment of the wearable computing device 100. In particular, the audio input data may represent sounds caused by a user of the wearable computing device 100 tapping, clicking, chattering, or otherwise striking two or more of the user's teeth together. In some embodiments, in block 404 the wearable computing device 100 may monitor one or more air microphones 132. The microphones 132 may detect sound caused by the user's teeth being tapped together and transmitted through air. As described above, the microphones 132 may be spatially separated in order to provide stereo or other positional audio data. In some embodiments, in block 406 the wearable computing device 100 may monitor one or more in-ear microphones 132. The in-ear microphones 132 may be positioned in or nearby the user's ear canal, for example as part of an earbud headphone or other in-ear monitor. By being positioned in the user's ear, the in-ear microphones 132 may detect reduced amounts of ambient noise as compared to an external, air microphone 132. As described above, the in-ear microphones 132 may be spatially separated (e.g., positioned in both ear canals) in order to provide stereo or other positional audio data.

In some embodiments, in block 408 the wearable computing device 100 may monitor one or more bone conductance audio sensors 132. The bone conductance audio sensors 132 may detect acoustic signals transmitted through the user's bones from the user's teeth being tapped together. Because bone conducts lower frequency sound better than air, the bone conductance audio sensors 132 may provide an audio signal with very low delay and perturbation. As described above, the bone conductance sensors 132 may be spatially separated (e.g., positioned on either side of the user's head) in order to provide stereo or other positional audio data.

In block 410, the wearable computing device 100 detects one or more teeth-tapping events based on the audio input data. Each teeth-tapping event corresponds with the user causing two or more of the user's teeth to come into contact, producing a sound or acoustic vibration. Additionally, the wearable computing device 100 may continually detect teeth-tapping events in order to detect groups or other patterns of teeth-tapping events, as described further below. The wearable computing device 100 may use any audio processing algorithm capable of detecting a characteristic audio signal pattern associated with a teeth-tapping event. In particular, the audio signal pattern associated with teeth-tapping events is relatively stable and located in low frequencies. For example, the wearable computing device 100 may match the audio input data against the characteristic audio signal pattern associated with teeth-tapping events.

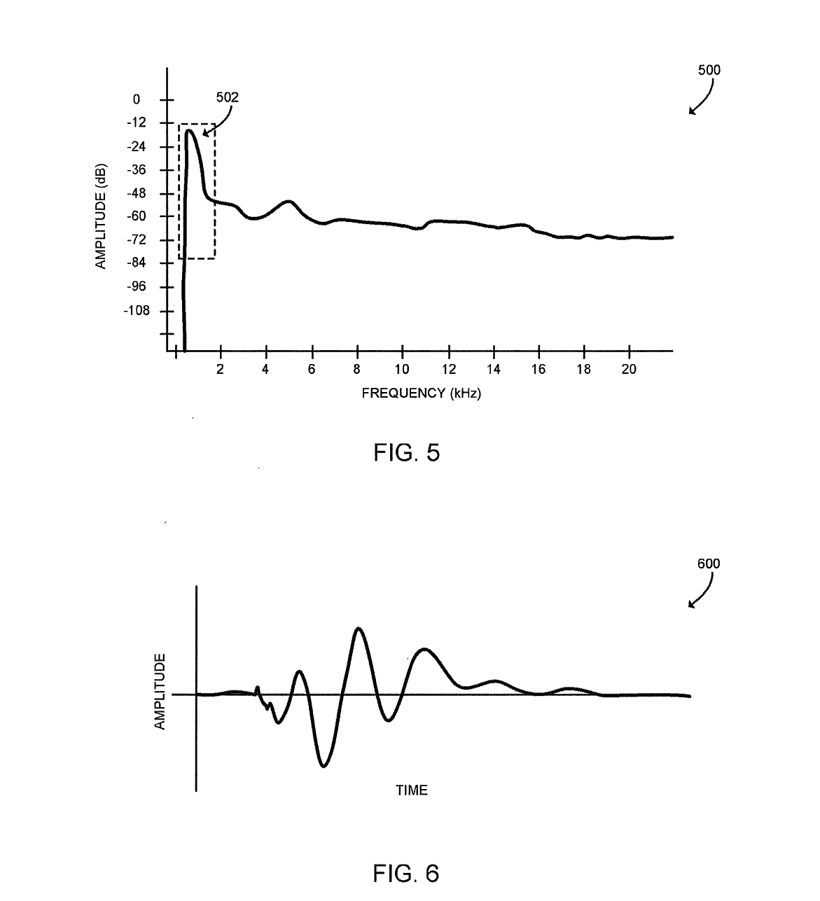

Referring now to FIG. 5, plot 500 illustrates amplitude versus frequency for a simulated teeth-tapping event audio signal. The region 502 of the plot 500 illustrates the characteristic audio signal for a teeth-tapping event in the frequency domain. As shown, the teeth-tapping event audio signal has a relatively low frequency (e.g., in the illustrative embodiment below 2000 Hz). Referring now to FIG. 6, plot 600 illustrates amplitude versus time for a simulated teeth-tapping event audio signal. The plot 600 thus may correspond to the region 502 of FIG. 5. As described above, the audio signal for a teeth tapping event is relatively stable and located in low frequencies.

Referring back to FIG. 4, in some embodiments, in block 412 the wearable computing device 100 may remove ambient noise to isolate teeth-tapping sounds. The wearable computing device 100 may use any appropriate acoustics algorithm to remove the ambient noise. For example, the wearable computing device 100 may isolate low-frequency audio signals associated with the characteristic audio signal pattern associated with teeth-tapping events. Ambient noise (other than wind noise) typically occurs in frequencies other than the frequencies associated with teeth-tapping events. In some embodiments, the wearable computing device 100 may correlate audio data from two or more audio sensors 132 to reduce ambient noise. Additionally or alternatively, the wearable computing device 100 may include one or more hardware features to reduce ambient noise. For example, microphones 132 may be shielded or otherwise protected from the environment to reduce wind noise, or in-ear microphones 132 may be used to reduce ambient noise. As another example, bone conductance audio sensors 132 are in general insensitive to ambient noise. Thus, in some embodiments, a wearable computing device 100 that includes bone conductance audio sensors 132 may not algorithmically remove ambient noise.

In block 414, the wearable computing device 100 identifies a teeth-tapping command based on the detected teeth-tapping event or events. The teeth-tapping command corresponds to a particular user interaction requested by the user, and may correspond to one or more teeth-tapping events. The teeth-tapping command may include one or more attributes that are based on the associated teeth-tapping events. For example, in some embodiments in block 416 the wearable computing device 100 identifies a tap position associated with the teeth-tapping command. The tap position corresponds to the location of the user's teeth that were used to create the teeth-tapping event. For example, the tap location may be left, right, or center, based on which of the user's teeth were tapped together by the user. The wearable computing device 100 may identify the tap location by analyzing stereo audio data or other positional audio data received from the audio sensors 132. For example, the wearable computing device 100 may determine the tap location based on a delay time between audio signals in stereo audio data.

As another example, in some embodiments in block 418 the wearable computing device 100 may identify a tap pattern based on the teeth-tapping events. For example, the wearable computing device 100 may determine whether the user performed multiple teeth-tapping events in quick succession (e.g., double-tapping, triple-tapping, etc.). The wearable computing device 100 may reject spurious teeth-tapping events that are not associated with a user action by requiring a particular tap pattern. For example, the wearable computing device 100 may require double-tapping and thus may reject isolated single teeth-tapping events. The threshold delay time between successive teeth-tapping events may be configurable.

In block 420, the wearable computing device 100 selects a user interface operation based on the teeth-tapping command. The user interface operation may include any user interface selection, navigation command, or other device command that may be executed by the wearable computing device 100. The wearable computing device 100 may select between multiple potential user interface operations based on the particular teeth-tapping command performed by the user or based on attributes of the teeth-tapping command performed by the user. For example, in some embodiments in block 422 the wearable computing device 100 may select the user interface operation based on the tap position and/or the tap pattern associated with the teeth-tapping command.

In block 424, the wearable computing device 100 executes the selected user interface operation. As described above, the user interface operation may include any device command that may be executed by the wearable computing device 100. For example, the wearable computing device 100 may start playing music in response to a double-tap command, and may stop playing music in response to a triple-tap command. In some embodiments, in block 426 the wearable computing device 100 may execute a navigation command based on the tap position of the teeth-tapping command. For example, the wearable computing device 100 may provide a horizontally-oriented menu interface on the display 130, and the user may navigate left by performing a teeth-tapping command on the left side of the user's mouth and may navigate right by performing a teeth-tapping command on the right side of the user's mouth. In some embodiments, in block 428 the wearable computing device 100 may execute a user interface selection based on the teeth-tapping command. The user interface selection may perform an operation similar to a mouse click or a finger tap on a touchscreen. For example, the wearable computing device 100 may select a currently-highlighted menu item in response to a double-tap command or in response to a center-position teeth-tapping command. After executing the user interface operation, the method 400 loops back to block 402 to continue monitoring the audio sensors 132 for audio input data.

### EXAMPLES

Illustrative examples of the technologies disclosed herein are provided below. An embodiment of the technologies may include any one or more, and any combination of, the examples described below.

Example 1 includes a computing device for hands-free user interaction, the computing device comprising an audio sensor to generate audio input data; a tap detection module to detect one or more teeth-tapping events based on the audio input data, wherein each teeth-tapping event corresponds to a sound indicative of a user contacting two or more of the user's teeth together; and a command module to perform a user interface operation in response to detection of the one or more teeth-tapping events.

Example 2 includes the subject matter of Example 1, and wherein the audio sensor comprises an air microphone.

Example 3 includes the subject matter of any of Examples 1 and 2, and wherein the air microphone comprises an in-ear microphone.

Example 4 includes the subject matter of any of Examples 1-3, and further including a plurality of air microphones; and an audio module to receive stereo audio input data from the plurality of air microphones.

Example 5 includes the subject matter of any of Examples 1-4, and wherein the audio sensor comprises a bone conductance audio sensor.

Example 6 includes the subject matter of any of Examples 1-5, and further including a plurality of bone conductance audio sensors; and an audio module to receive stereo audio input data from the plurality of bone conductance audio sensors.

Example 7 includes the subject matter of any of Examples 1-6, and wherein to detect the one or more teeth-tapping events comprises to remove ambient noise from the audio input data.

Example 8 includes the subject matter of any of Examples 1-7, and wherein to perform the user interface operation comprises to identify a teeth-tapping command based on the one or more teeth-tapping events; and select the user interface operation based on the teeth-tapping command.

Example 9 includes the subject matter of any of Examples 1-8, and wherein to identify the teeth-tapping command comprises to identify a tap position associated with the teeth-tapping command based on the audio input data, wherein the tap position corresponds to a contact location of the two or more of the user's teeth within the user's mouth.

Example 10 includes the subject matter of any of Examples 1-9, and wherein to identify the tap position comprises to determine whether the tap position is a left position, a right position, or a center position.

Example 11 includes the subject matter of any of Examples 1-10, and wherein to select the user interface operation comprises to select the user interface operation based on the tap position.

Example 12 includes the subject matter of any of Examples 1-11, and wherein to select the user interface operation comprises to select a user interface navigation command based on the tap position.

Example 13 includes the subject matter of any of Examples 1-12, and wherein to identify the teeth-tapping command comprises to identify a tap pattern associated with the teeth-tapping command based on the audio input data.

Example 14 includes the subject matter of any of Examples 1-13, and wherein to identify the tap pattern comprises to identify two or more teeth-tapping events associated with the teeth-tapping command, wherein the two or more teeth-tapping events occur within a predefined time period.

Example 15 includes the subject matter of any of Examples 1-14, and wherein to select the user interface operation comprises to select a user interface operation based on the tap pattern.

Example 16 includes a method for hands-free user interaction, the method comprising receiving, by a computing device, audio input data from an audio sensor of the computing device; detecting, by the computing device, one or more teeth-tapping events based on the audio input data, wherein each teeth-tapping event corresponds to a sound indicative of a user contacting two or more of the user's teeth together; and performing, by the computing device, a user interface operation in in response to detecting the one or more teeth-tapping events.

Example 17 includes the subject matter of Example 16, and wherein receiving the audio input data comprises receiving audio input data from an air microphone of the computing device.

Example 18 includes the subject matter of any of Examples 16 and 17, and wherein the air microphone comprises an in-ear microphone.

Example 19 includes the subject matter of any of Examples 16-18, and wherein receiving the audio input data further comprises receiving stereo audio input data from a plurality of air microphones of the computing device.

Example 20 includes the subject matter of any of Examples 16-19, and wherein receiving the audio input data comprises receiving audio input data from a bone conductance audio sensor of the computing device.

Example 21 includes the subject matter of any of Examples 16-20, and wherein receiving the audio input data further comprises receiving stereo audio input data from a plurality of bone conductance audio sensors of the computing device.

Example 22 includes the subject matter of any of Examples 16-21, and wherein detecting the one or more teeth-tapping events comprises removing ambient noise from the audio input data.

Example 23 includes the subject matter of any of Examples 16-22, and wherein performing the user interface operation comprises identifying a teeth-tapping command based on the one or more teeth-tapping events; and selecting the user interface operation based on the teeth-tapping command.

Example 24 includes the subject matter of any of Examples 16-23, and wherein identifying the teeth-tapping command comprises identifying a tap position associated with the teeth-tapping command based on the audio input data, wherein the tap position corresponds to a contact location of the two or more of the user's teeth within the user's mouth.

Example 25 includes the subject matter of any of Examples 16-24, and wherein identifying the tap position comprises determining whether the tap position is a left position, a right position, or a center position.

Example 26 includes the subject matter of any of Examples 16-25, and wherein selecting the user interface operation comprises selecting the user interface operation based on the tap position.

Example 27 includes the subject matter of any of Examples 16-26, and wherein selecting the user interface operation comprises selecting a user interface navigation command based on the tap position.

Example 28 includes the subject matter of any of Examples 16-27, and wherein identifying the teeth-tapping command comprises identifying a tap pattern associated with the teeth-tapping command based on the audio input data.

Example 29 includes the subject matter of any of Examples 16-28, and wherein identifying the tap pattern comprises identifying two or more teeth-tapping events associated with the teeth-tapping command, wherein the two or more teeth-tapping events occur within a predefined time period.

Example 30 includes the subject matter of any of Examples 16-29, and wherein selecting the user interface operation comprises selecting a user interface operation based on the tap pattern.

Example 31 includes a computing device comprising a processor; and a memory having stored therein a plurality of instructions that when executed by the processor cause the computing device to perform the method of any of Examples 16-30.

Example 32 includes one or more machine readable storage media comprising a plurality of instructions stored thereon that in response to being executed result in a computing device performing the method of any of Examples 16-30.

Example 33 includes a computing device comprising means for performing the method of any of Examples 16-30.

Example 34 includes a computing device for hands-free user interaction, the computing device comprising means for receiving audio input data from an audio sensor of the computing device; means for detecting one or more teeth-tapping events based on the audio input data, wherein each teeth-tapping event corresponds to a sound indicative of a user contacting two or more of the user's teeth together; and means for performing a user interface operation in in response to detecting the one or more teeth-tapping events.

Example 35 includes the subject matter of Example 34, and wherein the means for receiving the audio input data comprises means for receiving audio input data from an air microphone of the computing device.

Example 36 includes the subject matter of any of Examples 34 and 35, and wherein the air microphone comprise an in-ear microphone.

Example 37 includes the subject matter of any of Examples 34-36, and wherein the means for receiving the audio input data further comprises means for receiving stereo audio input data from a plurality of air microphones of the computing device.

Example 38 includes the subject matter of any of Examples 34-37, and wherein the means for receiving the audio input data comprises means for receiving audio input data from a bone conductance audio sensor of the computing device.

Example 39 includes the subject matter of any of Examples 34-38, and wherein the means for receiving the audio input data further comprises means for receiving stereo audio input data from a plurality of bone conductance audio sensors of the computing device.

Example 40 includes the subject matter of any of Examples 34-39, and wherein the means for detecting the one or more teeth-tapping events comprises means for removing ambient noise from the audio input data.

Example 41 includes the subject matter of any of Examples 34-40, and wherein the means for performing the user interface operation comprises means for identifying a teeth-tapping command based on the one or more teeth-tapping events; and means for selecting the user interface operation based on the teeth-tapping command.

Example 42 includes the subject matter of any of Examples 34-41, and wherein the means for identifying the teeth-tapping command comprises means for identifying a tap position associated with the teeth-tapping command based on the audio input data, wherein the tap position corresponds to a contact location of the two or more of the user's teeth within the user's mouth.

Example 43 includes the subject matter of any of Examples 34-42, and wherein the means for identifying the tap position comprises means for determining whether the tap position is a left position, a right position, or a center position.

Example 44 includes the subject matter of any of Examples 34-43, and wherein the means for selecting the user interface operation comprises means for selecting the user interface operation based on the tap position.

Example 45 includes the subject matter of any of Examples 34-44, and wherein the means for selecting the user interface operation comprises means for selecting a user interface navigation command based on the tap position.

Example 46 includes the subject matter of any of Examples 34-45, and wherein the means for identifying the teeth-tapping command comprises means for identifying a tap pattern associated with the teeth-tapping command based on the audio input data.

Example 47 includes the subject matter of any of Examples 34-46, and wherein the means for identifying the tap pattern comprises means for identifying two or more teeth-tapping events associated with the teeth-tapping command, wherein the two or more teeth-tapping events occur within a predefined time period.

Example 48 includes the subject matter of any of Examples 34-47, and wherein the means for selecting the user interface operation comprises means for selecting a user interface operation based on the tap pattern.

1-25. (canceled)

26. A computing device for hands-free user interaction, the computing device comprising:
an audio sensor to generate audio input data;
a tap detection module to detect one or more teeth-tapping events based on the audio input data, wherein each teeth-tapping event corresponds to a sound indicative of a user contacting two or more of the user's teeth together; and
a command module to perform a user interface operation in response to detection of the one or more teeth-tapping events.

27. The computing device of claim 26, wherein the audio sensor comprises an in-ear microphone.

28. The computing device of claim 26, wherein the audio sensor comprises an air microphone, the computing device further comprising:
a plurality of air microphones; and
an audio module to receive stereo audio input data from the plurality of air microphones.

29. The computing device of claim 26, wherein the audio sensor comprises a bone conductance audio sensor.

30. The computing device of claim 26, wherein to detect the one or more teeth-tapping events comprises to remove ambient noise from the audio input data.

31. The computing device of claim 26, wherein to perform the user interface operation comprises to:
identify a teeth-tapping command based on the one or more teeth-tapping events; and
select the user interface operation based on the teeth-tapping command.

32. The computing device of claim 31, wherein to identify the teeth-tapping command comprises to identify a tap position associated with the teeth-tapping command based on the audio input data, wherein the tap position corresponds to a contact location of the two or more of the user's teeth within the user's mouth.

33. The computing device of claim 32, wherein to select the user interface operation comprises to select the user interface operation based on the tap position.

34. The computing device of claim 33, wherein to select the user interface operation comprises to select a user interface navigation command based on the tap position.

35. The computing device of claim 34, wherein to identify the teeth-tapping command comprises to identify a tap pattern associated with the teeth-tapping command based on the audio input data.

36. The computing device of claim 35, wherein to identify the tap pattern comprises to identify two or more teeth-tapping events associated with the teeth-tapping command, wherein the two or more teeth-tapping events occur within a predefined time period.

37. A method for hands-free user interaction, the method comprising:
receiving, by a computing device, audio input data from an audio sensor of the computing device;
detecting, by the computing device, one or more teeth-tapping events based on the audio input data, wherein each teeth-tapping event corresponds to a sound indicative of a user contacting two or more of the user's teeth together; and
performing, by the computing device, a user interface operation in in response to detecting the one or more teeth-tapping events.

38. The method of claim 37, wherein receiving the audio input data comprises receiving audio input data from an in-ear microphone of the computing device.

39. The method of claim 37, wherein receiving the audio input data comprises receiving stereo audio input data from a plurality of air microphones of the computing device.

40. The method of claim 37, wherein receiving the audio input data comprises receiving audio input data from a bone conductance audio sensor of the computing device.

41. The method of claim 37, wherein performing the user interface operation comprises:
identifying a teeth-tapping command based on the one or more teeth-tapping events; and
selecting the user interface operation based on the teeth-tapping command.

42. The method of claim 41, wherein identifying the teeth-tapping command comprises identifying a tap position associated with the teeth-tapping command based on the audio input data, wherein the tap position corresponds to a contact location of the two or more of the user's teeth within the user's mouth.

43. The method of claim 41, wherein identifying the teeth-tapping command comprises identifying a tap pattern associated with the teeth-tapping command based on the audio input data.

44. One or more computer-readable storage media comprising a plurality of instructions that in response to being executed cause a computing device to:
receive audio input data from an audio sensor of the computing device;
detect one or more teeth-tapping events based on the audio input data, wherein each teeth-tapping event corresponds to a sound indicative of a user contacting two or more of the user's teeth together; and
perform a user interface operation in in response to detecting the one or more teeth-tapping events.

45. The one or more computer-readable storage media of claim 44, wherein to receive the audio input data comprises to receive audio input data from an in-ear microphone of the computing device.

46. The one or more computer-readable storage media of claim 44, wherein to receive the audio input data comprises to receive stereo audio input data from a plurality of air microphones of the computing device.

47. The one or more computer-readable storage media of claim 44, wherein to receive the audio input data comprises to receive audio input data from a bone conductance audio sensor of the computing device.

48. The one or more computer-readable storage media of claim 44, wherein to perform the user interface operation comprises to:
identify a teeth-tapping command based on the one or more teeth-tapping events; and
select the user interface operation based on the teeth-tapping command.

49. The one or more computer-readable storage media of claim 48, wherein to identify the teeth-tapping command comprises to identify a tap position associated with the teeth-tapping command based on the audio input data, wherein the tap position corresponds to a contact location of the two or more of the user's teeth within the user's mouth.

50. The one or more computer-readable storage media of claim 48, wherein to identify the teeth-tapping command comprises to identify a tap pattern associated with the teeth-tapping command based on the audio input data.
